(19) United States
(12) Patent Application Publication
(10) Pub. No.: US 2014/0279933 A1
(43) Pub. Date: Sep. 18, 2014

(54) Hashing Schemes for Managing Digital Print Media

(71) Applicant: Kevin Blasko, Burlingame, CA (US)

(72) Inventor: Kevin Blasko, Burlingame, CA (US)

(73) Assignee: KONICA MINOLTA LABORATORY U.S.A., INC., San Mateo, CA (US)

(21) Appl. No.: 13/830,529

(22) Filed: Mar. 14, 2013

(51) Int. Cl. G06F 17/30

(52) U.S. Cl. CPC G06F 17/3007
USPC 707/687

(57) ABSTRACT

A method for managing digital files, including the steps of generating a main hash for a new file, searching for a matching main hash of any existing file in storage, if a matching main hash is found, then stop from further processing the new file, but if no match is found, then generating a sub-hash for a sub-part of the new file, and searching for a matching sub-hash of any existing file in storage; if no match of the sub-hash is found, then processing the entire new file and saving the processed new file in the storage, if a matching sub-hash for a sub-part of an existing file is found, then processing only the remaining part of the new file that is not the sub-part for which the sub-hash is generated, and retrieving the matching sub-part of the existing file; and saving the processed remaining part of the new file and the retrieved sub-part of the existing file in storage as a combined digital file. An alternative process uses component and composite hashes generated for the component parts of digital files for detecting duplicates.

### BACKGROUND OF THE INVENTION

1. Field of the Invention

This invention relates to a method of managing digital print media, and in particular, it relates to managing digital print media files with hashing schemes for different component parts of a document prepared, stored, distributed and used in digital print media file formats.

2. Description of Related Art

Digital print media has been widely used now in modern document management and printing technologies. Documents that are traditionally printed, distributed and viewed in hard (paper) copies are increasingly available in electronic (digital) media formats, such as the portable document format (PDF).

Documents in digital print media, such as PDF files, are typically stored in an electronic file depository device, and managed through an indexing database. For example, when a PDF file is saved in a file storage medium, a hash of the file can be generated and saved in a database. The hash is used as an identification or index of the file for management purposes. For example, when a new PDF file is to be saved in storage, a hash of the new file can be generated, and compared with existing hashes in the database to see whether there is a match in the hashes.

If there is a match in the hashes, then it indicates that the new PDF file is identical to an existing PDF file already saved in storage, and there is no need to save the new PDF file again. This can avoid saving duplicate files in storage, which saves storage space. It also saves the time and resource for processing the new file if it is to be saved into storage. Often times before a PDF file is to be saved into file storage, certain necessary processing operations are performed, such as checking to see whether the file contains color pages, checking to see whether any pages need to be rotated and rotating such pages, etc. These file processing operations may be time consuming and occupy or use precious computing power and resources of the computer system and application programs that perform such file processing operations. If it is determined that a new PDF file is duplicative and needs not to be processed and saved in file storage again, then it will avoid the waste of further processing time and consumption of system resources.

It has been observed that more and more documents in digital print media contain multiple component parts. For example, in an educational institution, many course booklets are prepared, stored, distributed and viewed in digital print media such as PDF files. A PDF file of a booklet therefore typically contains, for example, a component part for a title page, a component part for a table of contents, and multiple component parts each for a chapter of the booklet, etc.

In current digital print media management schemes that utilize hashes, it is typical to generate one hash for a PDF file of an entire booklet and save that hash into the database for managing the PDF file of the booklet. When a new PDF file of another booklet is to be saved in file storage, a hash of the new PDF file of the other booklet is generated, and compared to the existing hashes in the database. If there is no match in the hash database, which means no identical PDF file existed in storage, then the new PDF file will be saved in storage.

There is a need to provide a new method for managing documents prepared, distributed, stored and used in digital print media such as PDF files, that can reduce the usage of time and resources in processing duplicative contents in different digital print media files, by reducing the duplicative processing of identical digital print media files or identical sub-parts of digital print media files.

### SUMMARY

The above described conventional digital print media management scheme has several shortcomings. For example, assuming a PDF file of a course booklet has already been saved in storage, where the first page of PDF file is the title page with a title of the booklet as “COURSE BOOK FOR YEAR 2012”, and a hash for this PDF file has also been generated and saved in the database. Assuming now there is a new PDF file of a new course booklet and the new course book is the same as the existing one except it is for year 2013. So the first page of the new PDF file is the title page with a title of the new booklet as “COURSE BOOK FOR YEAR 2013”. Otherwise the new PDF of the 2013 course booklet is identical to the existing PDF file of the 2012 course booklet. When a new hash for the new PDF file of the 2013 booklet is generated, it is of course different than the hash for the existing PDF file of the 2012 booklet because their title pages are different. So when a search is performed through the database, no matching hash will be found that is identical to the new hash of the new PDF file, and as a result the new PDF file of the 2013 booklet will be processed and saved in file storage.

This means that all the component parts of the new PDF file of the 2013 booklet, including the ones that are identical to the corresponding component parts of the existing PDF file of the 2012 booklet (in this example that will be all component parts except the one for the title page), will be processed again. This results in wasting processing time and computer resources in digital print media management.

The embodiments of the present invention are directed to a new method of managing digital print media with composite hashes that identify different component parts of a document prepared and stored in digital print media such as a PDF file.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, an exemplary embodiment of the present invention provides a method for managing digital files in a storage, including the steps of generating a main hash for a new digital file, and searching for a matching main hash of any existing digital file stored in the storage. If a matching main hash is found, then the process stops from further processing the new digital file, but if no match of the main hash is found, then a sub-hash for a sub-part of the new digital file is generated, and the process searches for a matching sub-hash of any existing digital file located in the storage. If no match of the sub-hash is found, then the entire new digital file is processed and the processed new digital file is saved in the storage, but if a matching sub-hash for a sub-part of an existing digital file is found, then only the remaining part of the new digital file that is not the sub-part for which the sub-hash is generated is processed, and the sub-part of the existing digital file for which the matching sub-hash is found is retrieved. Finally the processed remaining part of the new digital file and the retrieved sub-part of the existing digital file are saved in the storage as a combined digital file.

In another aspect, another exemplary embodiment of the present invention provides a method for managing digital files in a storage, including the steps of generating a component hashes for each component part of a new digital file, generating a composite hash for the new digital file containing all of its component hashes, and searching for a matching composite hash of any existing digital file stored in the storage. If a matching composite hash is found, then the process stops from further processing the new digital file. If no match of the composite hash is found, then for each component hash of the new digital file, the process searches for a matching component hash of any existing digital file located in the storage. If no match is found for a searched component hash of the new digital file, then the component part of the new digital file that corresponds to the searched non-matching component hash is processed. If a matching component hash for a component part of an existing digital file is found, then the component part of the existing digital file is retrieved. Finally all processed component parts of the new digital file and all retrieved component parts of existing digital files are saved in the storage as a combined digital file.

In another aspect, one exemplary embodiment of the present invention further provides a computer program product that causes a data processing apparatus to perform the above described methods. The computer program product includes a computer usable non-transitory medium (e.g. memory or storage device) having a computer readable program code embedded therein for controlling a data processing apparatus, the computer readable program code configured to cause the data processing apparatus to execute the above described processes.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online environment according to an embodiment of the present invention.

FIG. 2 is a schematic block diagram illustrating an exemplary data processing apparatus such as a computer or server according to the embodiment of the present invention shown in FIG. 1.

FIG. 3 is a schematic block diagram illustrating an exemplary printing or copying device having a data processing unit according to the embodiment of the present invention shown in FIG. 1.

FIG. 4 is a flow chart diagram illustrating an exemplary process for managing documents in digital print media such as PDF files with a multi-tiered hashing scheme according to one of the embodiments of the present invention.

FIG. 5 is a flow chart diagram illustrating an exemplary process for preparing a hash database of existing digital print media files saved in a storage device according to the embodiment of the present invention shown in FIG. 4.

FIG. 6 is a schematic block diagram illustrating an exemplary two-tiered hashing scheme according to the embodiment of the present invention shown in FIG. 4.

FIG. 7 is a flow chart diagram illustrating an exemplary process for managing documents in digital print media such as PDF files with a composite hashing scheme according to another one of the embodiments of the present invention.

FIG. 8 is a flow chart diagram illustrating an exemplary process for preparing a hash database of existing digital print media files saved in a storage device according to the embodiment of the present invention shown in FIG. 7.

FIG. 9 is a schematic block diagram illustrating an exemplary composite hashing scheme according to the embodiment of the present invention shown in FIG. 7.

### DETAILED DESCRIPTION OF PREFERRED EMBODIMENTS

Embodiments of the present invention provide a method and system for managing documents in digital print media such as PDF files with hashing schemes that assist in avoiding duplicative processing of identical files or file components in order to save precious computer resources and processing time. The present invention digital print media management method may be implemented by a computer software program, saved in a computer usable non-transitory medium, that has program codes and instructions for implementing the steps of the various processes in accordance with the present invention.

An exemplary application of the method for managing digital print media according to embodiments of the present invention may be illustrated in the following examples. Currently in a system managing digital storage of academic course booklets, a single unitary hash is used for an entire booklet to prevent a duplicate booklet from being created or stored again in the digital storage.

However often times a new booklet and an existing booklet are only different in their cover pages. But a searching based on the unitary hashes of the booklets will not return a match because their hashes are different due to the difference in their cover pages.

However, if two or more hashes comprised of different aspects of a booklet are used, then individual aspects of a booklet may be checked for duplicates. One approach may be generating a sub-hash of the entire booklet content minus the cover/title page. This is useful when an author wants to keep the same content of his/her booklet but needs to update the cover page to reflect the new title.

By referencing this sub-hash, the minor change in the cover/title page may be detected when this occurs, and only the cover page on the booklet needs to be processed and saved with the remaining contents of the booklet copied over from the existing booklet. This is far less processor intensive than regenerating the entire booklet over again.

Therefore the main purposes and objectives of this application of the embodiments of the present invention include: detecting the occurrence of duplicate sections of booklets, which may include but not limited to cover pages, TOC pages, and pages of individual articles; and reducing the processing required when a duplicate is found, by leaving the duplicate part of the booklet intact and intelligently processing only the non-duplicate part, which can reduce system load and computing time.

Accordingly, when a new booklet is being created or uploaded to storage, a composite hash is generated which includes component hashes that may encompass both visible and non-visible elements of the booklet. After the component hashes are created, they can be compared against existing hashes of previously stored booklets.

Multiple component hashes may be combined in various ways to determine more precisely which parts of a booklet has changed or updated. If any duplicate parts are found, then only the non-duplicate parts of the booklet will be processed, leaving the duplicate parts of the booklet intact.

Referring to FIG. 1, there is shown a schematic block diagram illustrating an exemplary online system set up or arrangement 10 in which various embodiments of the present invention may be implemented. The exemplary online system 10 includes one or more digital print media management servers 12 which is connected to an open interconnected computer network such as the Internet 14, where the computer program implementing the various processes of the embodiments of the present invention may be installed and executed.

The digital print media management server 12 is connected via the Internet 14 with one or more consumer or user computers 16. The digital print media management server 12 may be also connected via the Internet 14 with one or more third party servers 18.

In this application, the term “user” generally refers to a user, a customer, or anyone who uses the method or related apparatus provided by the embodiments of the present invention, and the term “third party servers” generally include any third party content providers, data services, file depositories, media resources, etc.

The exemplary system 10 also includes a data storage device 20 which may be an internal or external electronic storage device of the digital print media management server 12 directly accessible by the digital print media management server 12. The data storage device 20 may also be accessible by the user computer 16 through the digital print media management server 12 indirectly, and/or accessible by the user computer 16 via the Internet 14. The data storage device 20 includes a file depository 22 for saving and storing documents in digital print media such as PDF files.

A database or index system 24 of the digital files stored in the file depository 22 is also saved and maintained in the data storage 20. The database 24 contains information of the digital files stored in the file depository 22.

The information saved in the database of the digital files may be searched through the database 24. Such information of a digital file may include file name, size and dates of creation and modification, title and author of the document, number of pages, etc. The file information may be contained in entries of database tables, spreadsheets, etc. The file information may also be contained in meta tags or other coded devices associated with the file, such as hash codes, barcodes, etc.

Referring to FIG. 2, there is shown a schematic block diagram illustrating an exemplary data processing apparatus such as a computer or server 100, whereupon various embodiments of the present invention may be implemented. The computer or server 100 typically includes an input device 110 including, for example, a keyboard and a mouse.

The input device 110 may be connected to the data processing apparatus 100 through a local input/output (I/O) port 120 to enable an operator and/or user to interact with the data processing apparatus 110. The computer or server 100 typically also has a network I/O port 130 for connection to a network such as the Internet so that the computer or server 100 may remotely communicate with the other computers and servers connected to the Internet.

The computer or server 100 typically has a data processor/controller unit 140 such as a central processor unit (CPU) that controls the functions and operations of the computer or server 100. The data processor/controller unit 140 is connected to various memory devices such as a random access memory (RAM) device 150, a read only memory (ROM) device 160, and a storage device 170 such as a hard disc drive or solid state memory. The storage device 170 may be an internal memory device or an external memory device. The computer software programs and instructions for implementing the various embodiments of the present invention may be installed or saved on one or more of these memory devices.

The data processor/controller unit 140 executes these computer software programs and instructions to perform the functions and carry out the operations to implement the process steps of the various embodiments of the present invention.

The computer or server 100 typically also include a display device 180 such as a video monitor or display screen. The input device 110 and the display device 180 together provide a user interface (UI) which allows a user to interact with the computer or server 100 to perform the steps of the process according to the various embodiments of the present invention. The input device 110 and the display device 180 may be integrated into one unit, such as a touch screen, to provide the UI for user interaction with the computer or server 100.

It is understood that data processing apparatus 100 may be any suitable computer or computer system. Preferably for use by a digital file management service provider, the data processing apparatus 100 is a server computer. However, for use by a customer of the digital management service, the data processing apparatus 100 may be a desktop computer, a laptop computer, a notebook computer, a netbook computer, a tablet computer, a hand-held portable computer or electronic device, a smart phone, or any suitable data processing apparatus that has suitable data processing capabilities.

Referring to FIG. 3, there is shown a schematic block diagram illustrating another exemplary data processing apparatus embodied in a document reproduction device such as a printer or copier 200, whereupon various embodiments of the present invention may also be implemented. The printer or copier 200 typically includes an integrated control panel 210 which includes a keypad and a display screen, or a touch screen that provides both the input and display functions.

The printer or copier 200 may has a local I/O port 220 for connection with other local devices such as a computer. The printer or copier 200 typically also has a network I/O port 230 for connection to a network such as the Internet so that the printer or copier 200 may remotely communicate with the other computers and servers connected to the Internet.

The printer or copier 200 typically has a data processor/controller unit 240 that controls the functions and operations of the printer or copier 200. The data processor/controller unit 240 is connected to various memory devices such as a RAM device 250, a ROM device 260, and a storage device 270 such as a hard disc drive or solid state memory. The storage device 270 may be an internal memory device or an external memory device. The computer software programs and instructions for implementing the various embodiments of the present invention may be installed or saved on one or more of these memory devices.

The data processor/controller unit 240 executes these computer software programs and instructions to perform the functions and carry out the operations to implement the process steps of the various embodiments of the present invention.

It is understood that the data processing apparatus 200 may be any suitable document reproduction device or system, such as a printer, a copier, a scanner, a facsimile machine, an all-in-one printer, a printing system, or any suitable document reproduction device that has suitable data processing capabilities.

Referring back to FIG. 1, in digital print media management operations, one of the tasks is to manage the digital files stored in the data depository 22. For example, documents are prepared and generated as PDF files, which can be uploaded online from a user computer 16 and saved in the file depository 22. However, before a new file can be saved into the depository 22, it needs to be processed by the digital print media management server 12.

These processing steps include, for example, checking to see whether an existing PDF files already saved in the depository 22 is identical to the new PDF file and if so, there is no need to further process the new PDF file and save it to the depository 22 to avoid duplicative files. If there is no identical PDF file exists in the depository 22, then the new PDF file will be processed (e.g., checking for color pages, rotating miss-oriented pages, etc.) and then saved to the depository 22.

As mentioned earlier, digital file information is gathered from the files stored in the depository 22, and such information is saved in the database 24. When checking whether an existing PDF files already saved in the depository 22 is identical to the new PDF file, the search is conducted through the file information entries of the database 24. For example, one of the many alternative ways of searching for an identical existing file is through the hash code generated for the digital files.

When a PDF file is stored in the depository 22, its hash code can be generated and saved in the database 24. As a new PDF file is uploaded, its hash code may be obtained (if it has been previously generated and provided with the new PDF file) or newly generated (if none exists). A search is then conducted through the hash code entries in the database 24, which hash codes are of the existing PDF files stored in the depository 22.

The hash code of the new PDF file is compared to the hash codes of the existing PDF files. If there is a match in the hash codes of the new and existing PDF files, then the new PDF file will not be processed and stored in the depository 22. If there is no match in the hash codes, then no identical PDF file existed in the depository 22, and the new PDF file will be processed and saved in the depository 22.

However, it has been observed that often times the differences between a newly uploaded PDF file and an existing PDF file stored in the depository 22 are very limited. For example, the existing PDF file may be a 100-page document which is a course booklet wherein the first page is the title page and the remaining 99 pages are content pages, and the new PDF file is also a 100-page document which is the same course booklet except the first page contains a new title but the remaining 99 content pages are identical to the 99 content pages the existing PDF file.

However, because of the difference in the title pages, the hash code of the new PDF file will be different from the hash code of the existing PDF file. Therefore when a search is performed, no matching hash will be found and the entire new PDF file will be processed, despite the fact that the 99 content pages of the booklet have previously been processed before the existing PDF file was stored in the depository 22. This duplicate processing of the majority of pages of the new PDF file is a waste of processing time and computer resources that can be avoided by the implementation of the embodiments of the present invention.

Referring to FIG. 4, there is shown a flow chart diagram illustrating an exemplary process for managing documents in digital print media such as PDF files with a multi-tiered hashing scheme according to an embodiment of the present invention. Particularly, the exemplary process for managing PDF files shown in FIG. 4 is a two-tiered hashing scheme, as will be described in detail below.

In order to implement the two-tiered hash scheme according to the embodiment of the present invention as shown in FIG. 4, the database 24 of the existing PDF files already stored in the depository 22 need to be supplemented with hash codes prepared in accordance with the two-tiered hashing scheme.

Referring to FIGS. 5 and 6, there is illustrated the exemplary process for preparing a hash database of existing digital print media files saved in a storage device according to the two-tiered hashing scheme embodiment of the present invention. The steps shown in FIGS. 5 and 6 may be performed by digital print media management server 12 in conjunction with data storage 20 including file depository 22 and database 24.

At step S12, an existing PDF file is retrieved from the depository 22 by digital print media management server 12. The PDF file contains a first page which typically is the cover/title page, and the remaining pages (after the first page) are deemed as content pages.

At step S14, a main hash of the entire PDF file with all of its pages including the cover/title page is generated by digital print media management server 12. It is noted that if the PDF file is supplied with such a hash code which is saved in the database 24, or such a hash code has previously been generated and saved in the database 24, then this step S14 can be omitted.

Next at step S16, a sub-hash for the content pages (e.g., the remaining pages after the first page) is also generated by digital print media management server 12. This sub-hash contains no information from the first (cover/title) page and therefore is not associated with the first (cover/title) page.

At step S18, both the main hash and the sub-hash of the existing PDF file are saved in the database 24 by digital print media management server 12. This means that this existing PDF file stored in the depository 22 will have two hashes associated with it and saved in the database 24: a first tier main hash for all pages of the existing PDF file, and a second tier sub-hash for only the content pages of the existing PDF file.

Therefore, after all existing PDF files stored in the depository 22 are processed by the two-tiered hashing scheme preparation process described above, each existing PDF file stored in the depository 22 will have two associated hashes including a first tier main hash and a second tier sub-hash saved in the database 24. The first tier main hash contains information of all pages of the corresponding existing PDF file, and the second tier sub-hash contains information of only the content pages of the same PDF file, as the relationship shown in FIG. 6.

Referring back to FIG. 4, when a new PDF file is uploaded at step S112 by a user from, for example, user computer 16 or a third party server 18, a main hash of the entire new PDF file will be generated by digital print media management server 12 at step S114. The process of generating the main hash is similar to the one described in conjunction with FIG. 5. Then at step S116 a search will be conducted by digital print media management server 12 through database 24 to check whether there exists a matching main hash of an existing PDF file stored in the depository 22.

At step S122, if a match is found in database 24, then it means that an identical PDF file exists in the depository 22, and there is no need to further process and save the new PDF file, so the process will promptly end. This avoids processing the new PDF file and storing two duplicate PDF files in the depository 22.

However, if no match is found at step S122, then a sub-hash of the content pages (after the first cover/title page) of new PDF file will also be generated by digital print media management server 12 at step S124. The process of generating the sub-hash is also similar to the one described in conjunction with FIG. 5.

Then at step S126 another search will be conducted by digital print media management server 12 through database 24 to check whether there exists a matching sub-hash of an existing PDF file stored in the depository 22.

At step S128, if no match is found in database 24, then the entire new PDF file will be processed by digital print media management server 12 at step S132 and stored in the depository 22 at step S134. Following that at step S152 both the main hash and the sub-hash of the new PDF file are saved by digital print media management server 12 in the database 24, such that the new PDF file stored in the depository 22 will also have two hashes associated with it and saved in the database 24: a first tier main hash for all pages of the new PDF file, and a second tier sub-hash for only the content pages of the new PDF file.

However, if a match is found in database 24 at step S128, then it means that an existing PDF in the depository 22 has content pages that are identical to the content pages of the new PDF file.

Therefore, at step S142, only the first (cover/title) page of the new PDF file is processed (e.g., checking to see if it a color page, whether it needs to be rotated, etc.) by digital print media management server 12 because that is the only different page between the new and existing PDF files.

Since the remaining content pages of the new PDF file are the same as the content pages of the existing PDF file, there is no need to further process these content pages of the new PDF file. Rather, the identical content pages of the existing PDF file are retrieved by digital print media management server 12 from the depository 22 at step S144.

At step 146, the processed first (cover/title) page of the new PDF file and the retrieved identical content pages of the existing PDF file are combined by digital print media management server 12 and saved as a new PDF file in the depository 22. In essence, the identical content pages of the existing PDF file are copied over and used as the content pages of the new PDF file because these pages have been previously processed. This avoids processing the content pages of the new PDF file, which saves precious computing resources and processing time.

Again, the last step of this process is step S152 wherein both the main hash and the sub-hash of the new PDF file are saved by digital print media management server 12 in the database 24. As a result, each new PDF file stored in the depository 22 will have two hashes associated with it and saved in the database 24, including a first tier main hash for all pages of the new PDF file, and a second tier sub-hash for only the content pages of the new PDF file.

Once saved in the depository 22, the new PDF file becomes an “existing” PDF file. At the same time, both of its two-tiered hashes saved in the database 24 are independently and individually searchable in the future when another new PDF file is uploaded from user computer 12 or a third party server 18 and needs to be processed and stored by digital print media management server 12.

It is noted that while a two-tiered hashing scheme is described above as one of the embodiments of the present invention, this process design can be easily adopted and applicable to a three-tiered hashing scheme. For example, in a three-tiered hashing scheme, when preparing the database 24 of existing PDF files stored in the depository 22 (i.e., similar to the preparation process shown in FIG. 5), the first tier hash may be generated from all pages of an existing PDF file stored in depository 22, the second tier hash may be generated from all but the first page of the existing PDF file, and the third tier hash may be generated from all but the first five pages of the existing PDF file. This is because if two PDF files are nearly identical (e.g., different editions of a same work), it is more likely that only the first few pages of the two PDF files are different. Once the three-tiered hashes of all existing PDF files are generated and saved in the database 24, then when a new PDF file is uploaded and needs to be processed (i.e., similar to the process shown in FIG. 4), after the step S128 when no match second tier hash is found, a search for a matching third-tier hash in the database 24 may be conducted, and so on. Therefore, this process design can be easily adopted and applicable to a multi-tiered hashing scheme.

Referring to FIG. 7, there is shown a flow chart diagram illustrating another exemplary process for managing documents in digital print media such as PDF files with a composite hash scheme according to an alternative embodiment of the present invention.

Again, in order to implement the composite hash scheme according to the alternative embodiment of the present invention as shown in FIG. 7, the database 24 of the existing PDF files already stored in the depository 22 need to be supplemented with hash codes prepared in accordance with the composite hashing scheme.

Referring to FIGS. 8 and 9, there is illustrated the exemplary process for preparing a hash database of existing digital print media files saved in a storage device according to the composite hashing scheme embodiment of the present invention. The steps shown in FIGS. 5 and 6 may be performed by digital print media management server 12 in conjunction with data storage 20 including file depository 22 and database 24. At step S22, an existing PDF file is retrieved by digital print media management server 12 from the depository 22. In many instances the PDF file comes with information about its page count and page “distribution”. For example, the page distribution information may reveal that page 1 is the cover/title page, page 2 is the table of contents (TOC) page, pages 3-5 are the pages of Chapter 1, pages 6-8 are the pages of Chapter 2, pages 9-11 are the pages of Chapter 3, and page 12 is the end/index page, as shown in FIG. 9. If such page count and distribution information is available for the PDF file, it may be used to divide the pages of the PDF file.

Conventionally only a single unitary hash is generated for the entire PDF file (including all pages). According to this embodiment of the present invention, the different parts of the PDF file are considered its component parts. For example, the PDF file shown in FIG. 9 is considered to have six component parts, including a first component part for the cover/title page, a second component part for the TOC page(s), a third, fourth and fifth component part for Chapters 1-3 respectively, and a sixth component part for the end/index page(s).

At step S24, a component hash for each component part of the PDF file is generated by digital print media management server 12. Therefore, for the exemplary PDF file shown in FIG. 9, six component hashes will be generated, including a first component hash for the first component part for the cover/title page, a second component hash for the second component part for the TOC page(s), a third component hash for the third component part for Chapter 1, a fourth component hash for the fourth component part for Chapter 2, a fifth component hash for the fifth component part for Chapter 3, and a sixth component hash for the sixth component part for the end/index page(s).

At step S26, a composite hash of the PDF file is generated by digital print media management server 12 from all of the component hashes of the PDF file, and at step S28, the composite hash is saved in the database 24 with all of its component hashes each individually searchable. This will ensure that when a new PDF file is uploaded for processing, each of its component parts may be separately searched for matching component part from the existing PDF files.

After all existing PDF files stored in the depository 22 are processed by the composite hashing scheme preparation process described above, each existing PDF file stored in the depository 22 will have an associated composite hash including all of its component hashes (for all the component parts of the existing PDF file) saved in the database 24, wherein each component hash contains information of the pages of the corresponding component part of the existing PDF file, as the relationship shown in FIG. 9.

Referring back to FIG. 7, when a new PDF file is uploaded by a user from, for example, user computer 12 or a third party server 18 at step S212, a component hash of each component part of the new PDF file will be generated by digital print media management server 12 at step S214, and then at step S216 a composite hash for the new PDF file will also be generated by digital print media management server 12, which includes all of the component hashes generated at step S214. The process of generating the component hashes and the composite hash is similar to the one described in conjunction with FIG. 8.

At step S218 a search will be conducted by digital print media management server 12 through database 24 to check whether there exists a matching composite hash of an existing PDF file stored in the depository 22. If a match is found at step S222, then it means that an identical PDF file exists in the depository 22, and there is no need to further process and save the new PDF file, so the process will promptly end. Again, this avoids processing the new PDF file and storing two duplicate PDF files in the depository 22.

However, if no match is found in database 24 at step S222, then for each component hash of the new PDF file, a new search will be conducted by digital print media management server 12 at step S224 through database 24 to check whether there exists a matching component hash of an existing PDF file stored in the depository 22. This process will continue until all component hashes of the new PDF file are processed, i.e., a search is conducted and either a match is found or not found.

At step S226, if no match is found in database 24 for a component hash of the new PDF file, then the corresponding component part of the new PDF file will be processed by digital print media management server 12 at step S232 (e.g., checking to see if it a color page, whether it needs to be rotated, etc.) because that component part of the new PDF file does not exist in the existing PDF files stored in the depository 22.

However, if a match is found in database 24 at step S226, then it means that an existing PDF in the depository 22 has a component part that is identical to the component part of the new PDF file corresponding to the matched component hash. Therefore, at step S234, the identical component part of the existing PDF file is retrieved by digital print media management server 12 from the depository 22. Since the component part (that corresponds to a matching component hash) of the new PDF file is the same as the retrieved component part of the existing PDF file, there is no need to further process that component part of the new PDF file.

At step 236, the processed component parts of the new PDF file (for which no identical component part is found from the existing PDF files stored in depository 22) and the retrieved identical component parts of existing PDF files are combined and saved by digital print media management server 12 as a new PDF file in the depository 22. Again, essentially the identical component parts of existing PDF files are copied over and used as the component parts of the new PDF file because these component parts of existing PDF files have already been previously processed. This results in saving of precious computing resources and processing time.

The last step of this alternative process is step S238 wherein the composite hash of the new PDF file is saved by digital print media management server 12 in the database 24 with all of its component hashes independently and individually searchable. As a result, each new PDF file stored in the depository 22 will have a composite hash associated with it and saved in the database 24, including all of its component hashes.

Once saved in the depository 22, the new PDF file becomes an “existing” PDF file, with its composite hash and all component hashes saved in the database 24 and independently and individually searchable in the future when another new PDF file is uploaded and needs to be processed and stored.

The above described process may be implemented by a computer software program. The various embodiments of the present invention also provides a computer program product that includes a computer usable non-transitory medium (e.g. memory or storage device) having a computer readable program code embedded therein for controlling a data processing apparatus, the computer readable program code configured to cause the data processing apparatus to execute the above described process.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for managing digital files in a storage, comprising the steps of:
generating a main hash for a new digital file;
searching for a matching main hash of any existing digital file stored in the storage;
whereas if a matching main hash is found, then stop from further processing the new digital file;
if no match of the main hash is found, then generating a sub-hash for a sub-part of the new digital file, and searching for a matching sub-hash of any existing digital file stored in the storage;
if no match of the sub-hash is found, then processing the entire new digital file and saving the processed new digital file in the storage;
whereas if a matching sub-hash for a sub-part of an existing digital file is found, then processing only the remaining part of the new digital file that is not the sub-part for which the sub-hash is generated, and retrieving the sub-part of the existing digital file for which the matching sub-hash is found; and
saving the processed remaining part of the new digital file and the retrieved sub-part of the existing digital file in the storage as a combined digital file.

2. The method of claim 1, further comprising a step of saving the main hash and the sub-hash of the new digital file in the storage.

3. The method of claim 1, further comprising a step of generating a main hash for an existing digital file stored in the storage.

4. The method of claim 3, further comprising a step of generating a sub-hash for a sub-part of the existing digital file stored in the storage.

5. The method of claim 4, further comprising a step of saving the main hash and the sub-hash of the existing digital file in the storage.

6. A method for managing digital files in a storage, comprising the steps of:
generating a component hashes for each component part of a new digital file;
generating a composite hash for the new digital file containing all of its component hashes;
searching for a matching composite hash of any existing digital file stored in the storage;
whereas if a matching composite hash is found, then stop from further processing the new digital file;
if no match of the composite hash is found, then for each component hash of the new digital file, searching for a matching component hash of any existing digital file stored in the storage;
if no match is found for a searched component hash of the new digital file, then processing the component part of the new digital file that corresponds to the searched non-matching component hash;
whereas if a matching component hash for a component part of an existing digital file is found, then retrieving the component part of the existing digital file; and
saving all processed component parts of the new digital file and all retrieved component parts of existing digital files in the storage as a combined digital file.

7. The method of claim 6, further comprising a step of saving the composite hash of the new digital file in the storage with all of its component hashes independently searchable.

8. The method of claim 6, further comprising a step of generating a component hash for each component part of an existing digital file stored in the storage.

9. The method of claim 8, further comprising a step of generating a composite hash for the existing digital file stored in the storage containing all of its component hashes.

10. The method of claim 9, further comprising a step of saving the composite hash of the existing digital file in the storage with all of its component hashes independently searchable.

11. A computer program product comprising a non-transitory computer usable medium having a computer readable code embodied therein for controlling a data processing apparatus, the computer readable program code configured to cause the data processing apparatus to execute a process for managing digital files in a storage, the process comprising the steps of:
generating a main hash for a new digital file;
searching for a matching main hash of any existing digital file stored in the storage;
whereas if a matching main hash is found, then stop from further processing the new digital file;
if no match of the main hash is found, then generating a sub-hash for a sub-part of the new digital file and searching for a matching sub-hash of any existing digital file stored in the storage;
if no match of the sub-hash is found, then processing the entire new digital file and saving the processed new digital file in the storage;
whereas if a matching sub-hash for a sub-part of an existing digital file is found, then processing only the remaining part of the new digital file that is not the sub-part for which the sub-hash is generated, and retrieving the sub-part of the existing digital file for which the matching sub-hash is found; and
saving the processed remaining part of the new digital file and the retrieved sub-part of the existing digital file in the storage as a combined digital file.

12. The computer program product of claim 11, wherein the process further comprises a step of saving the main hash and the sub-hash of the new digital file in the storage.

13. The computer program product of claim 11, wherein the process further comprises a step of generating a main hash for an existing digital file stored in the storage.

14. The computer program product of claim 13, wherein the process further comprises a step of generating a sub-hash for a sub-part of the existing digital file stored in the storage.

15. The computer program product of claim 14, wherein the process further comprises a step of saving the main hash and the sub-hash of the existing digital file in the storage.

16. A computer program product comprising a non-transitory computer usable medium having a computer readable code embodied therein for controlling a data processing apparatus, the computer readable program code configured to cause the data processing apparatus to execute a process for managing digital files in a storage, the process comprising the steps of:
generating a component hashes for each component part of a new digital file;
generating a composite hash for the new digital file containing all of its component hashes;
searching for a matching composite hash of any existing digital file stored in the storage;
whereas if a matching composite hash is found, then stop from further processing the new digital file;
if no match of the composite hash is found, then for each component hash of the new digital file, searching for a matching component hash of any existing digital file stored in the storage;
if no match is found for a searched component hash of the new digital file, then processing the component part of the new digital file that corresponds to the searched non-matching component hash;
whereas if a matching component hash for a component part of an existing digital file is found, then retrieving the component part of the existing digital file; and
saving all processed component parts of the new digital file and all retrieved component parts of existing digital files in the storage as a combined digital file.

17. The computer program product of claim 16, wherein the process further comprises a step of saving the composite hash of the new digital file in the storage with all of its component hashes independently searchable.

18. The computer program product of claim 16, wherein the process further comprises a step of generating a component hash for each component part of an existing digital file stored in the storage.

19. The computer program product of claim 18, wherein the process further comprises a step of generating a composite hash for the existing digital file stored in the storage containing all of its component hashes.

20. The computer program product of claim 19, wherein the process further comprises a step of saving the composite hash of the existing digital file in the storage with all of its component hashes independently searchable.
